(19) United States
(12) Patent Application Publication
(10) Pub. No.: US 2023/0165201 A1
(43) Pub. Date: Jun. 1, 2023

(54) POT WITH INTEGRATED IRRIGATION

(71) Applicant: William James Hausauer, Cold Lake (CA)

(72) Inventor: William James Hausauer, Cold Lake (CA)

(21) Appl. No.: 17/457,045

(22) Filed: Dec. 1, 2021

(51) Int. Cl. A01G 27/00; A01G 9/02

(52) U.S. Cl. CPC A01G 27/008; A01G 27/005; A01G 9/02

(57) ABSTRACT

A pot with integrated irrigation that is provided in a single pot embodiment or in a networked embodiment having a plurality of pots wherein the present invention provides an ability to provide automated watering of plants disposed within the interior volume of the pots. The present invention includes a pot having a body wherein the body includes an upper circumferential edge. A peripheral fluid tube member is integrally formed into the upper circumferential edge and is operable to have water flow therethrough. A plurality of fluid distribution tube members are operably coupled to the peripheral fluid tube member and are oriented so as to distribute water into the interior volume of the pot. The fluid distribution tube members have fluid ejection ports and can be present in various quantities. A reservoir is provided to store water and includes a pump to move the water to the pots via tubes.

### FIELD OF THE INVENTION

The present invention relates generally to horticultural implements and accessories, more specifically but not by way of limitation, a pot that includes integrated irrigation wherein the pot can be supplied in a single embodiment or be supplied in a network of pots.

### BACKGROUND

As is known in the art, many different types of plants are grown in various containers. Whether for food or for ornamental reasons, plants provide many benefits to the areas in which they are planted. It is common for a typical household to utilize areas such as but not limited to garden boxes to plant various species that include but are not limited to food or fruit bearing plants. Another vessel that is common to utilize to grow plants are pots. Pots come in various sizes and shapes and are manufactured from many different types of materials.

While pots provide great growing areas for plants of all types they do offer challenges for the user. One challenge is the proper irrigation of the plants once they have been planted into the pot. Existing pots do not have any irrigation capabilities. While existing pots are constructed to facilitate the proper drainage there is no mechanism to facilitate water distribution. Users of pots must commonly transport water from a source using various vessels or port a hose end to the location of the pots. This can be time consuming as often the pots having plants therein are in alternate locations. Additionally, if a user is absent for an extended period of time they must make arrangements for the plants to be watered.

Accordingly, there is a need for a pot configured to have planted therein at least one plant wherein the pot is configured to have integrated irrigation and can be further configured into a network of pots all being fluidly coupled.

### SUMMARY OF THE INVENTION

It is the object of the present invention to provide a pot having integrated irrigation so as to distribute water to the interior volume of the pot wherein the present invention includes a body having a bottom and at least one wall forming an interior volume.

Another object of the present invention is to provide a pot provided as a single embodiment or configurable into an operable network of a plurality of pots all being fluidly coupled wherein the body of the present invention includes an upper circumferential edge.

A further object of the present invention is to provide a pot having integrated irrigation so as to distribute water to the interior volume of the pot wherein the upper circumferential edge has integrally formed therewith a peripheral fluid tube member.

Still another object of the present invention is to provide a pot provided as a single embodiment or configurable into an operable network of a plurality of pots all being fluidly coupled wherein the peripheral fluid tube member includes a hollow passage therethrough.

An additional object of the present invention is to provide a pot having integrated irrigation so as to distribute water to the interior volume of the pot that further includes a plurality of fluid distribution tube members operably coupled to the peripheral fluid tube member.

Yet a further object of the present invention is to provide a pot provided as a single embodiment or configurable into an operable network of a plurality of pots all being fluidly coupled wherein the fluid distribution tube members are positioned within the interior volume of the body.

Another object of the present invention is to a provide a pot having integrated irrigation so as to distribute water to the interior volume of the pot wherein the fluid distribution tube members include a plurality of fluid ejection ports.

An alternate object of the present invention is to provide a pot provided as a single embodiment or configurable into an operable network of a plurality of pots all being fluidly coupled that further includes a fluid reservoir and pump operably coupled to the peripheral fluid tube member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of a single embodiment of the present invention; and

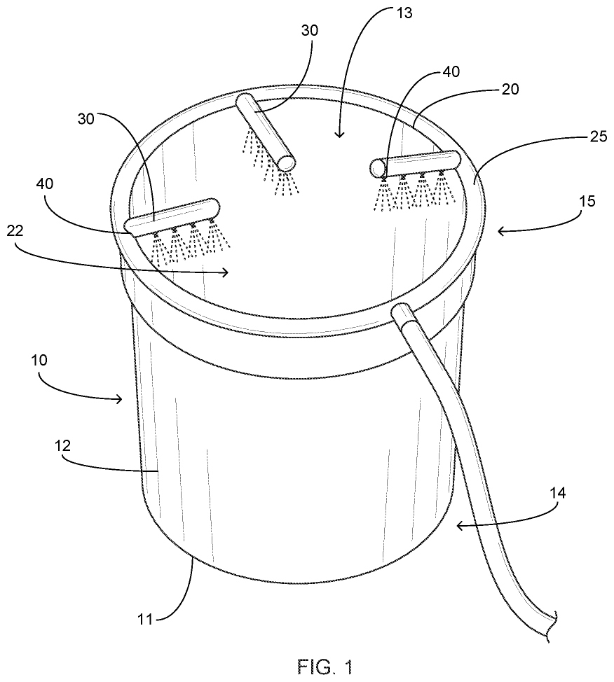

FIG. 2 is a diagrammatic view of an exemplary network of pots of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a pot with integrated irrigation 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted herewith, the pot with integrated irrigation 100 includes a body 10. The body 10 includes a bottom 11 and a wall 12 wherein the bottom 11 and wall 12 are integrally formed to create an interior volume 13. The body 10 includes lower end 14 and upper end 15. While the body 10 illustrated herein shows an annular shape having one wall 12, it is contemplated within the scope of the present invention that the body 10 could be formed with alternate quantities of walls in order to provide different shapes of the body 10. Furthermore, it should be understood within the scope of the present invention that the body 10 could be provided in various sizes and manufactured from alternate suitable material such as but not limited to plastic or clay.

The body 10 includes an upper circumferential edge 20 proximate the upper end 15 that is surroundably present to the opening 22 providing access to the interior volume 13. Integrally formed with the upper circumferential edge 20 is the peripheral fluid tube member 25. The peripheral fluid tube member 25 is annular in formed and includes a hollow passage 26 therethrough. The peripheral fluid tube member 25 extends completely around the upper circumferential edge 20 and is integrally formed therewith utilizing suitable techniques. It should be understood within the scope of the present invention that the peripheral fluid tube member 25 will be mateably shaped to whatever the shape is of the upper circumferential edge 20. It is contemplated within the scope of the present invention that the peripheral fluid tube member 25 could be provided in various diameters in order to provide alternate volumes of fluid therethrough.

Operably coupled to the peripheral fluid tube member 25 are a plurality of fluid distribution tube members 30. The fluid distribution tube members 30 are tubular in shape and manufactured from a suitable material such as but not limited to plastic. The fluid distribution tube members 30 are hollow so as to accept a fluid from the peripheral fluid tube member 25 and are further oriented inward towards the interior volume 13 of the body 10. The fluid distribution tube members 30 are operable to provide a distribution of water or other fluid being supplied to a plant disposed within the interior volume 13 of the body 10. In a preferred embodiment the fluid distribution tube members 30 are arranged in a manner so that the fluid ejection ports 40 provide coverage of the substantially the entire surface area proximate the opening 22. It should be understood within the scope of the present invention that any number of fluid distribution tube members 30 could be provided in order to achieve the desired objective of delivering the proper amount of fluid to a plant disposed within the interior volume 13 of the body 10. It should be further understood within the scope of the present invention that the fluid distribution tube members 30 could be provided in alternate shapes, lengths and diameters in order to achieve the discussed objective. The fluid ejection ports 40 are located at the bottom of each of the fluid distribution tube members 30 and can be configured to discharge water in various spray patterns as needed. It should be understood within the scope of the present invention that the fluid distribution tube members 30 could have various quantities of fluid ejection ports 40.

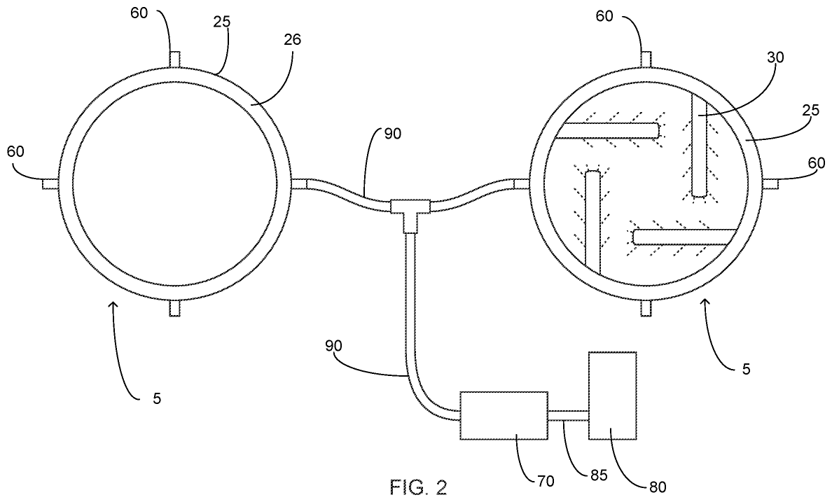

Now referring in particular to FIG. 2 submitted herewith, an exemplary networked configuration of the pot with integrated irrigation 100 is diagrammed therein. In this networked embodiment at least two pots 5 are fluidly coupled so as to provide the ability to distribute fluid and/or water to the plants disposed within the pots 5. In the networked embodiment the peripheral fluid tube member 25 is equipped with connection ports 60. The connection ports 60 are integrally formed with the peripheral tube member 25 utilizing suitable techniques and are operable to facilitate an operable connection with tubing 90 in order to assist in the transfer of fluid between pots 5. It should be understood within the scope of the present invention that the pot with integrated irrigation 100 could employ various quantities of connection ports 60 so as to facilitate an operable connection between alternate quantities of pots 5.

The connection ports 60 that are not operably coupled with tubing 90 can be capped with a suitable object so as to provide sealing thereof.

The tubing 90 is connected to a pump 70, which is fluidly coupled to a reservoir 80. The pump 70 is a conventional electric fluid pump that is configured to distribute water into the tubing 90 and as such to all peripheral fluid tube members 25 coupled thereto. The pump 70 cab be either provided with or coupled to a timer wherein the timer can program the operation of the pump 70 as needed to supply the desired amount of fluid to plants disposed within the pots 5. The reservoir 80 is of sufficient size so as to receive and store the amount of fluid needed for operation of the pot with integrated irrigation 100. It should be understood within the scope of the present invention that the reservoir 80 could be provided in alternate sizes and manufactured from various suitable materials. The reservoir 80 is operably coupled to the pump 70 via tube 85. It should be understood within the scope of the present invention that the pump 70 and reservoir 80 could be located distally to the pots 5 so as to avoid any undesired aesthetic appearance.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

1. A pot with integrated irrigation operable to provide water distribution to a plant disposed within the pot wherein the pot comprises:
a body, said body having a bottom and at least one wall forming an interior volume, said body having an upper end and a lower end, said body having an opening proximate said upper end configured to provide access to said interior volume;
a peripheral fluid tube member, said peripheral fluid tube member being integrally formed with the at least one wall of said body, said peripheral fluid tube member having a hollow passage so as to permit water to flow therethrough, said peripheral fluid tube member extending substantially around said opening of said body; and
at least one fluid distribution tube member, said at least one fluid distribution tube member being operably coupled to said peripheral fluid tube member, said at least one fluid distribution tube member extending inwards towards said interior volume of said body, said at least one fluid distribution tube member being hollow so as to permit water to flow therethrough for deposit into said interior volume of said body.

2. The pot with integrated irrigation operable to provide water distribution as recited in claim 1, and further including at least one fluid ejection port, said at least one fluid ejection port being formed in a bottom area of said at least one fluid distribution tube member, said at least one fluid ejection port operable to dispense water into said interior volume.

3. The pot with integrated irrigation operable to provide water distribution as recited in claim 2, and further including at least one connection port, said at least one connection port operably coupled with said peripheral fluid tube member, said at least one connection port providing an interface to operably couple at least one additional pot.

4. The pot with integrated irrigation operable to provide water distribution as recited in claim 3, and further including a reservoir, said reservoir configured to receive and store water, said reservoir fluidly coupled to said peripheral fluid tube member.

5. The pot with integrated irrigation operable to provide water distribution as recited in claim 4, and further including a pump, said pump operably coupled to said reservoir, said pump configured to transfer water from said reservoir to said peripheral fluid tube member.

6. The pot with integrated irrigation operable to provide water distribution as recited in claim 5, wherein said body is provided in alternate sizes.

7. A pot configured to have at least one plant disposed therein and dispense water proximate thereto wherein the pot comprises:
a body, said body having a bottom and a wall forming an interior volume, said body having an upper end and a lower end, said body having an upper circumferential edge proximate said upper end, said body having an opening proximate said upper end configured to provide access to said interior volume, said body being annular in shape;
a peripheral fluid tube member, said peripheral fluid tube member being integrally formed with the wall of said body proximate said upper circumferential edge, said peripheral fluid tube member having a hollow passage so as to permit water to flow therethrough, said peripheral fluid tube member extending around said opening of said body; and
a plurality of fluid distribution tube members, said plurality of fluid distribution tube members being operably coupled to said peripheral fluid tube member, said plurality of fluid distribution tube members extending inwards towards said interior volume of said body, said plurality of fluid distribution tube members being hollow so as to permit water to flow therethrough for deposit into said interior volume of said body, said plurality of fluid distribution tube members further including a plurality of fluid ejection ports formed in a bottom area of said plurality of fluid distribution tube members, said plurality of fluid ejection ports configured to dispense water into said interior volume of said body.

8. The pot configured to have at least one plant disposed therein and dispense water proximate thereto as recited in claim 7, and further including a reservoir, said reservoir configured to receive and store water, said reservoir fluidly coupled to said peripheral fluid tube member.

9. The pot configured to have at least one plant disposed therein and dispense water proximate thereto as recited in claim 8, and further including a plurality of connection ports, said a plurality of connection ports operably coupled with said peripheral fluid tube member, said a plurality of connection ports providing an interface to operably couple multiple additional pots.

10. The pot configured to have at least one plant disposed therein and dispense water proximate thereto as recited in claim 9, and further including a pump, said pump operably coupled to said reservoir, said pump configured to transfer water from said reservoir to said peripheral fluid tube member.

11. The pot configured to have at least one plant disposed therein and dispense water proximate thereto as recited in claim 10, and further including a tubing network, said tubing network configured to fluidly couple said reservoir, said pump and a plurality of pots.

12. The pot configured to have at least one plant disposed therein and dispense water proximate thereto as recited in claim 11, wherein said body is provided in alternate sizes.

13. An integrated irrigation system for use with a pot having a body and an interior volume, comprising:
a peripheral fluid tube member, the peripheral fluid tube member securable to the body of the pot, the peripheral fluid tube member having a hollow passage so as to permit water to flow therethrough and the peripheral fluid tube member extending around a portion of the body with access to the interior volume of the body; and
at least one fluid distribution tube member, the at least one fluid distribution tube member being operably coupled to the peripheral fluid tube member, the at least one fluid distribution tube member extending inwards towards the interior volume of the body and the at least one fluid distribution tube member being hollow so as to permit water to flow therethrough for deposit into the interior volume of the body.

14. The integrated irrigation system of claim 13, further comprising at least one fluid ejection port, the at least one fluid ejection port being formed in a bottom area of the at least one fluid distribution tube member and the at least one fluid ejection port operable to dispense water into the interior volume.

15. The integrated irrigation system of claim 14, further comprising at least one connection port, the at least one connection port operably coupled with the peripheral fluid tube member and the at least one connection port providing an interface to operably couple the integrated irrigation system to at least one additional pot.

16. The integrated irrigation system of claim 15, further comprising a reservoir, the reservoir configured to receive and store water and the reservoir fluidly coupled to the peripheral fluid tube member.

17. The integrated irrigation system of claim 16, further comprising a pump, the pump operably coupled to the reservoir and the pump configured to transfer water from the reservoir to the peripheral fluid tube member.

18. The integrated irrigation system of claim 17, wherein the peripheral tube member is provided in alternate size to accommodate alternate sizes of bodies.
